(19) United States
(12) Patent Application Publication
(10) Pub. No.: US 2009/0261633 A1
(43) Pub. Date: Oct. 22, 2009

(54) SEAT FOR A BICYCLE

(76) Inventor: Harald Schmid, Colog (DE)

Correspondence Address: NIKOLAI & MERSEREAU, P.A., 900 SECOND AVENUE SOUTH, SUITE 820, MINNEAPOLIS, MN, 55402, US

(21) Appl. No.: 12/357,904

(22) Filed: Jan. 22, 2009

(30) Foreign Application Priority Data
Apr. 17, 2008 (TW) 097206536

(51) Int. Cl. B62J 1/00; B62J 1/18

(52) U.S. Cl. 297/214; 297/215.16

(57) ABSTRACT

A seat for a bicycle has a seat body and a seat post. The seat body a front end, a rear end, a bottom and multiple reinforced ribs. The rear end has a width larger than that of the front end. The reinforced ribs are formed on the bottom of the seat body. The seat post is integrally formed on and protrudes from the bottom of the seat body. With the seat post being integrally formed on the seat body, the manufacturing process for the seat is simplified and the cost therefor is accordingly lowered.

### BACKGROUND OF THE INVENTION

1. Field of the Invention

The present invention relates to a seat, and more particularly to a seat for a bicycle.

2. Description of Related Art

With reference to FIG. 4, a conventional seat (80) for a bicycle in accordance with the prior art comprises seat body (81), two connecting rods (82), a clamping device (83) and a seat post (84). The connecting rods (82) are mounted on the bottom of and respectively at two sides of the seat body (81). The clamping device (83) adjustably clamps the connecting rods (82) and is connected to the seat post (84). The seat post (82) is connected to a frame of the bicycle to connect the seat (80) to the frame of the bicycle.

However, the conventional seat (80) a complicated structure implemented with multiple components, so to assemble the conventional seat (80) is difficult and troublesome and the cost for manufacturing the conventional seat (80) is high.

To overcome the shortcomings, the present invention tends to provide a seat for a bicycle to mitigate or obviate the aforementioned problems.

### SUMMARY OF THE INVENTION

The main objective of the invention is to provide a seat for a bicycle and that is easily manufactured with a lowered cost. The seat has a seat body and a seat post. The seat body a front end, a rear end, a bottom and multiple reinforced ribs. The rear end has a width larger than that of the front end. The reinforced ribs are formed on the bottom of the seat body. The seat post is integrally formed on and protrudes from the bottom of the seat body.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a seat for a bicycle in accordance with the present invention;

FIG. 2 is a bottom view of the seat in FIG. 1;

FIG. 3 is a perspective view of another embodiment of a seat for a bicycle in accordance with the present invention; and

FIG. 4 is a side view of a conventional seat for a bicycle in accordance with the prior art.

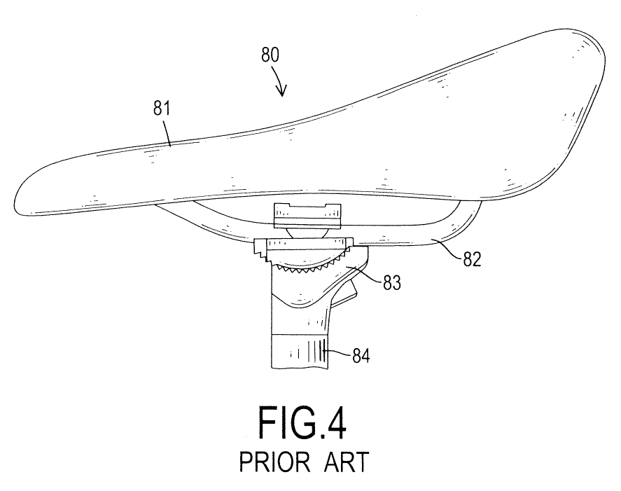

### DETAILED DESCRIPTION OF PREFERRED EMBODIMENT

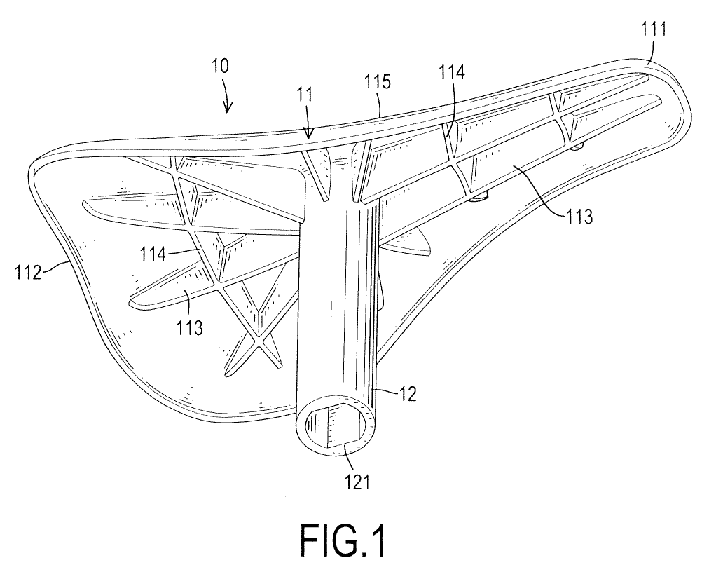

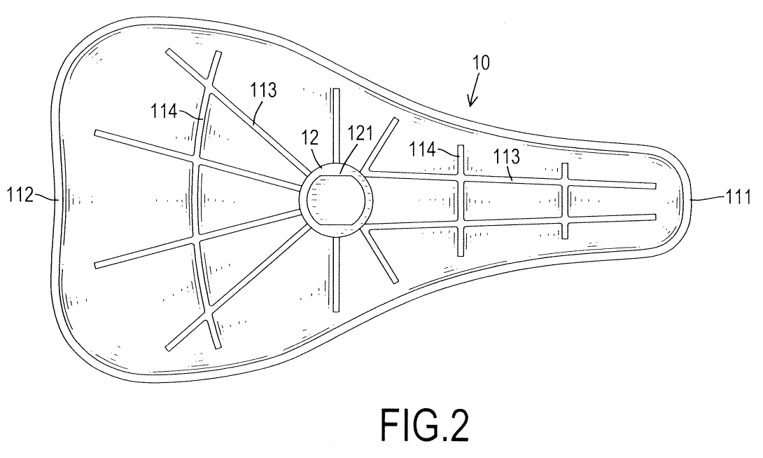

With reference to FIGS. 1 and 2, a seat (10) for a bicycle in accordance with the present invention comprises a seat body (11) and a seat post (12). The seat body (11) has a front end (111), a rear end (112), a top, a bottom, multiple reinforced ribs (113) and multiple lateral ribs (114). The front end (111) has a width smaller than that of the rear end (112), such that the seat body (11) has a substantial triangular shape, may be an isosceles triangular shape. The reinforced ribs (113) are formed on the bottom of the seat body (11). In a preferred embodiment, the reinforced ribs (113) are radically formed on the bottom of the seat body (11). The lateral ribs (114) are formed on the bottom of the seat body (11) and intersected with the reinforced ribs (113). With the arrangement of the ribs (113,114), the structural strength of the seat body (11) is enhanced.

The seat post (12) is integrally formed on and protrudes from the bottom of the seat body (11). In the preferred embodiment, the reinforced ribs (113) are radically formed on the bottom of the seat body (11) and have a center at the seat post (12). The seat post (12) has a top, a bottom, a hole and two reinforced walls (121). The top of the seat post (12) is integrally formed on and attached to the bottom of the seat body (11). The bottom of the seat post (12) is connected to a frame of the bicycle to connect the seat (10) to the frame of the bicycle. The hole is defined in the bottom of the seat post (12) and has an inner surface. The reinforced walls (121) are formed on the inner surface of the hole to increase the thickness of the seat post (12) at the positions corresponding to the reinforced walls (121), such that the structural strength of the seat post (12) is enhanced. Additionally, the reinforced walls (121) can make the hole having a non-circular cross section so as to keep the seat (10) from being rotated relative to the frame of the bicycle.

Because the seat body (11) and the seat post (12) is integrally formed together into a single piece by an injection mold process or the like, the process for manufacturing the seat (10) is easy and time-saving so that the manufacturing cost for the seat (10) is lowered.

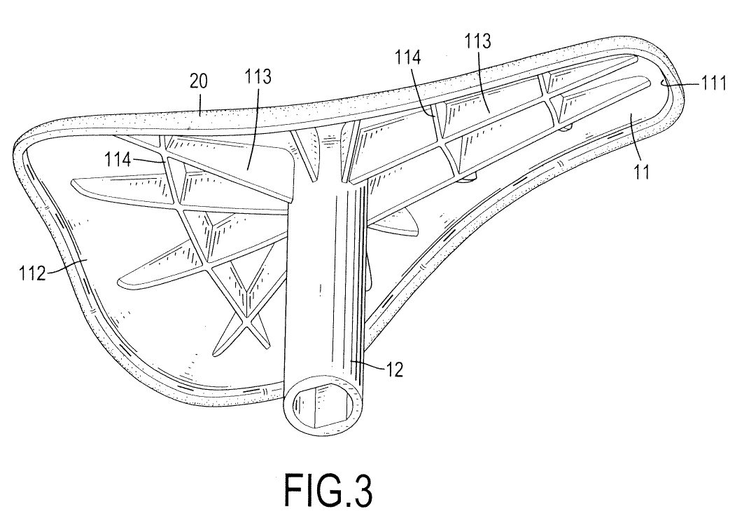

With reference to FIG. 3, the seat (10) in accordance with the present invention may further comprise an outer coat (20) being resilient and mounted around the top of the seat body (11). The outer coat (20) may be made of a foam rubber material, such as sponge or the like so as to provide a comfortable and buffering effect to a bicycle rider.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A seat for a bicycle comprising:
a seat body having
a front end with a width;
a rear end with a width larger than that of the front end;
a bottom; and
multiple reinforced ribs formed on the bottom of the seat body; and
a seat post integrally formed on and protruding from the bottom of the seat body.

2. The seat as claimed in claim 1, wherein the reinforced ribs are radically formed on the bottom of the seat body.

3. The seat as claimed in claim 2, wherein the reinforced ribs are radically formed on the bottom of the seat body and have a center at the seat post.

4. The seat as claimed in claim 3, wherein the seat body further has multiple lateral ribs formed on the bottom of the seat body and intersected with the reinforced ribs.

5. The seat as claimed in claim 4, wherein the seat post has
a thickness
a bottom;
a hole defined in the bottom of the seat post and having an inner surface; and
two reinforced walls formed on the inner surface of the hole to increase the thickness of the seat post at positions corresponding to the reinforced walls.

6. The seat as claimed in claim 5 further comprising an outer coat being resilient and mounted around a top of the seat body.

7. The seat as claimed in claim 1, wherein the seat body further has multiple lateral ribs formed on the bottom of the seat body and intersected with the reinforced ribs.

8. The seat as claimed in claim 2, wherein the seat body further has multiple lateral ribs formed on the bottom of the seat body and intersected with the reinforced ribs.

9. The seat as claimed in claim 1, wherein the seat post has
a thickness
a bottom;
a hole defined in the bottom of the seat post and having an inner surface; and
two reinforced walls formed on the inner surface of the hole to increase the thickness of the seat post at positions corresponding to the reinforced walls.

10. The seat as claimed in claim 1 further comprising an outer coat being resilient and mounted around a top of the seat body.
